(19) United States
(12) Patent Application Publication
(10) Pub. No.: US 2003/0167271 A1
(43) Pub. Date: Sep. 4, 2003

(54) RDO-to-PDF conversion tool

(76) Inventors: Wolfram Arnold, San Mateo, CA (US); Ian Henry, Fairfield, CA (US); Suresh Nirmal, Foster City, CA (US)

Correspondence Address: JAMES TROSINO, 268 BUSH STREET, #3434, SAN FRANCISCO, CA, 94104, US

(21) Appl. No.: 09/941,432

(22) Filed: Aug. 28, 2001

(51) Int. Cl. G06F 17/30; G06F 7/00

(52) U.S. Cl. 707/10

(57) ABSTRACT

A process and apparatus for analyzing the binary RDO file structure, extracting all relevant data needed to reproduce the content, and generation of output in the PDF format is disclosed. The conversion process to PDF takes the following steps: In the first step, the binary RDO file is read and analyzed. Its internal structure is decoded—parsed—and transferred into a data structure representation in memory. In the second step, the data contained within the RDO file describing the arrangement of pages in the final document is extracted. This step is separate due to the internal organization of the RDO file. The various pieces of data pertaining to different pages are scattered throughout the file and must be collected for each page in this step. In addition, there are some data that are page-invariant and that apply to the entire document, such as header and footer messages, their location, or font selection. Once all of these data are gathered, the output can be generated by placing one or more TIFF bitmap files for each page onto the output page and adding the optional text messages for header, footer and page number. When all pages have been processed in this way, the final PDF file is self-contained and stored on disk. When the data files are not TIFF but PostScript, the situation is slightly different. Because positioning instructions may be included with the PostScript file, the RDO file contains only the filename. In the conversion process, an external, commercially available Postscript-to-PDF converter must be invoked to merge these pages into the output PDF.

### BACKGROUND OF THE INVENTION

1. Technical Field

The invention relates to file format conversion. More particularly, the invention relates to a file filter application that converts documents stored in the RDO format to the PDF format.

2. Description of the Prior Art

The RDO format was designed around a document preparation system that permits the aggregation of pages from various input sources, such as scanned or electronic, into a single consistent document, with optional facilities to add consecutive page numbering and a header or footer for all pages. As a result of its focus on scanned input, the RDO format has been widely used to migrate paper records and books into electronic archives. Because the format and surrounding software applications that generate, process, and print RDO files, however, are proprietary, existing digital assets in RDO are accessible only through the manufacturer's products.

To make digital assets stored in RDO available to a larger audience and facilitate their public distribution, it would be desirable to convert the RDO files into an open format, such as PDF (see Portable Document Format (PDF), Adobe Systems, Inc.).

### SUMMARY OF THE INVENTION

The invention provides a process and apparatus for analyzing the binary RDO file structure, extracting all relevant data needed to reproduce the content, and generation of output in the PDF format.

The conversion process to PDF takes the following steps:

In the first step, the binary RDO file is read and analyzed. Its internal structure is decoded—parsed—and transferred into a data structure representation in memory.

In the second step, the data contained within the RDO file describing the arrangement of pages and images on the page in the final document is extracted. This step is separate due to the internal organization of the RDO file. The various pieces of data pertaining to different pages, such as location and orientation of the bitmaps, are scattered throughout the file and must be collected for each page in this step. In addition, there are some data that are page-invariant and that apply to the entire document, such as header and footer messages, their location, or font selection.

Once all of these data are gathered, the output can be generated by placing the TIFF bitmap files for each page onto the output page and adding the optional text messages for header, footer and page number. When all pages. have been processed in this way, the final PDF file is self-contained and stored on disk or sent to an output device.

When the data files are not in TIFF but PostScript format, the situation is slightly different. Because positioning instructions may be included with the PostScript file, the RDO file in this case contains only the filename. In the conversion process, an external, commercially available Postscript-to-PDF converter must be invoked to merge these pages into the output PDF.

### BRIEF DESCRIPTION OF THE DRAWINGS

FIG. 1 is a schematic diagram showing an overview of an RDO-to-PDF conversion process according to the invention;

FIG. 2 is a schematic diagram showing an overview of an XJT-to-generic job ticket conversion process according to the invention;

FIG. 3 is a schematic diagram showing tree structure of an RDO file;

FIG. 4 is a schematic diagram showing a parsing algorithm according to the invention; and

FIG. 5 is a schematic diagram showing a layout of an RDO file.

### DETAILED DESCRIPTION OF THE INVENTION

The presently preferred embodiment of the invention provides a process and apparatus for analyzing the binary RDO file structure, extracting all relevant data needed to reproduce the content, and generation of output in the PDF format. For purpose of the discussion herein, the RDO format refers to a collection of files. Typically, there is a file with an “.rdo” file extension and a subdirectory of the same name, but with a “.con” extension. The subdirectory contains a series of TIFF files (see TIFF, a raster image format standard, Adobe Systems, Inc.) which represent the actual page contents. Each page is stored as one or more TIFF image files, and the RDO file only contains the instructions of how to assemble the individual pages into the final document. For that purpose, RDO files contain the file names of all page image files and information on how to place the images onto a page, such as rotation, offsets, and margins. In addition, the RDO file may include text messages to be printed on each page, such as a header, footer, or page number. In some cases, when the page source was Adobe PostScript®, the PostScript file may actually be stored as well, or exclusively. Finally, there is a job ticket file having an extension “.xjt” which describes document finishing options and media selections.

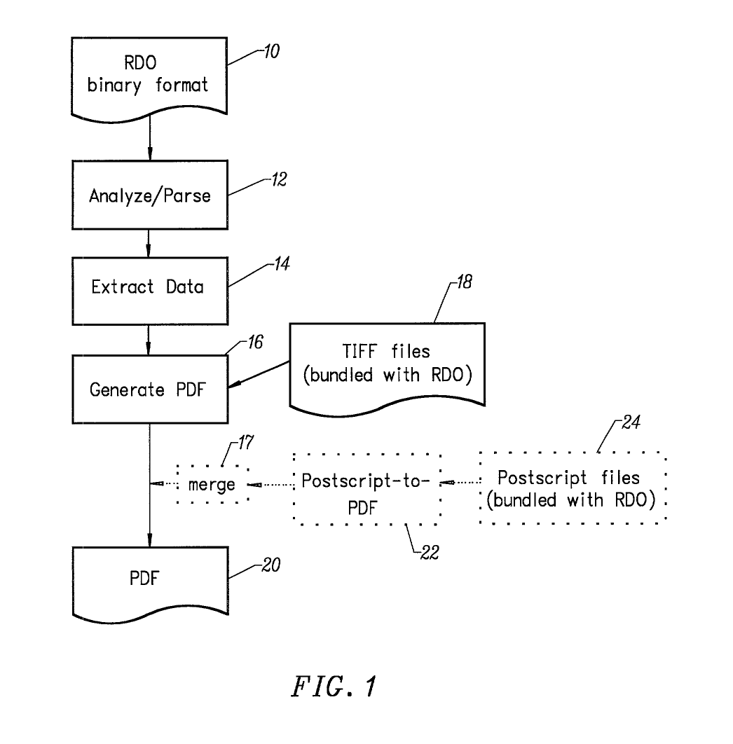

The conversion process to PDF takes the steps illustrated in FIG. 1.

In the first step, the binary RDO file 10 is read and analyzed 12. Its internal structure is decoded—parsed—and transferred into a data structure representation in memory.

In the second step, the data contained within the RDO file describing the arrangement of pages in the final document is extracted 14. This step is separate due to the internal organization of the RDO file. The various pieces of data pertaining to different pages are scattered throughout the file and must be collected for each page in this step. In addition, there are some page-invariant data that apply to the entire document, such as header and footer messages, their location, or font selection.

Once all of these data are gathered, the output can be generated by placing the TIFF bitmap files 18 for each page onto the output page 16 and adding the optional text messages for header, footer and page number. When all pages have been processed in this way, the final PDF file 20 is self-contained and stored on disk.

When the data files are not TIFF but PostScript, the situation is slightly different. Because positioning instructions may be included with the PostScript file, the RDO file contains only the filename. In the conversion process, an external, commercially available Postscript-to-PDF converter 22 must be invoked to merge 17 these pages 24 into the output PDF.

These three steps can be likened to the process of natural language translation of a written document. A human translator must first read 11 the document in the source language, then understand 13 it, and finally reproduce 15 it in the target language.

The discussion below describes a presently preferred implementation for each of these steps in greater detail.

Job Ticket Conversion

Before discussing the technical aspects of the RDO conversion, the following comments are provided relating to the job ticket that accompanies the RDO file. The purpose of a job ticket is to specify printing options that are not directly part of the document and that depend on the capabilities of the output device. The RDO format is most commonly used with the Xerox DocuTech printer family which support a range of finishing options such as:

stapling support of the document or sections of a document;

generation of booklets, i.e. stapling in the center and folding;

selection of different media types as cover sheets and/or at section boundaries;

duplex or simplex printing;

paper tray/paper size selection;

insertion of blank pages, e.g. paper exceptions, or pages printed on a different device, e.g. color; and

different stacking options.

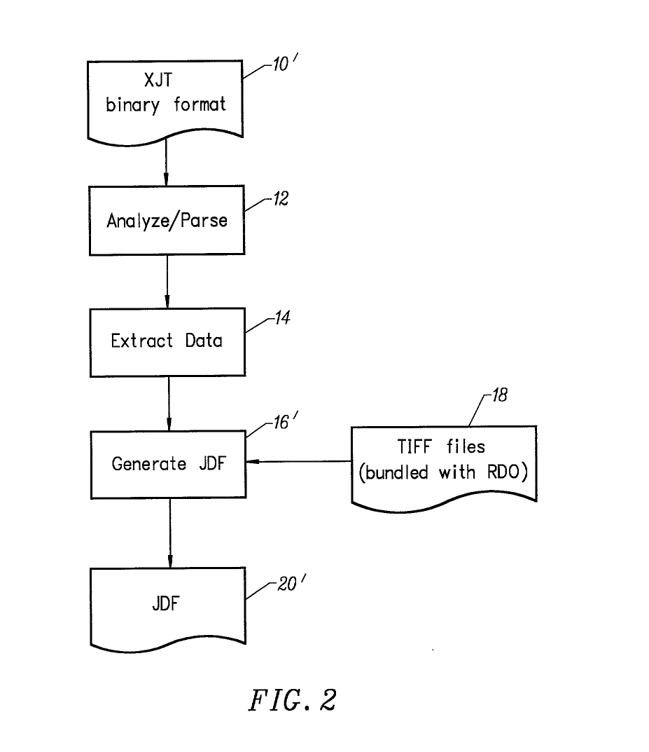

There is no proper standardized place for options such as these in common document formats such as PDF because many of these capabilities are highly specific to high-end production printers. There are currently a number of competing efforts ongoing to design a standardized format for the job ticket, but for the time being, most manufacturers still resort to proprietary solutions. One aspect of the invention concerns a mechanism for converting an XJT job ticket that accompanies RDO into an open format, for example an XML-based standard (see Extensible Markup Language (XML), Recommendation by World Wide Web Consortium (W3C), (http://www.w3.org/TR/REC-xml)), such as the JDF Draft Specification (see Job Definition Format (JDF), Draft by Adobe Systems Inc., AGFA-Gevaert N.V., Heidelberger Druckmaschinen AG, MAN Roland Druckmaschinen AG), in analogy to the RDO conversion, as depicted in FIG. 2 (where a document having an XJT binary format 10′ is analyzed/parsed 12, data are extracted therefrom 14, a job ticket file is generated 16′, and the JDF files is output 20′).

Parsing

The following discussion briefly explains how the data within the RDO file are encoded and how they can be represented in a computer data structure.

Tree Structure

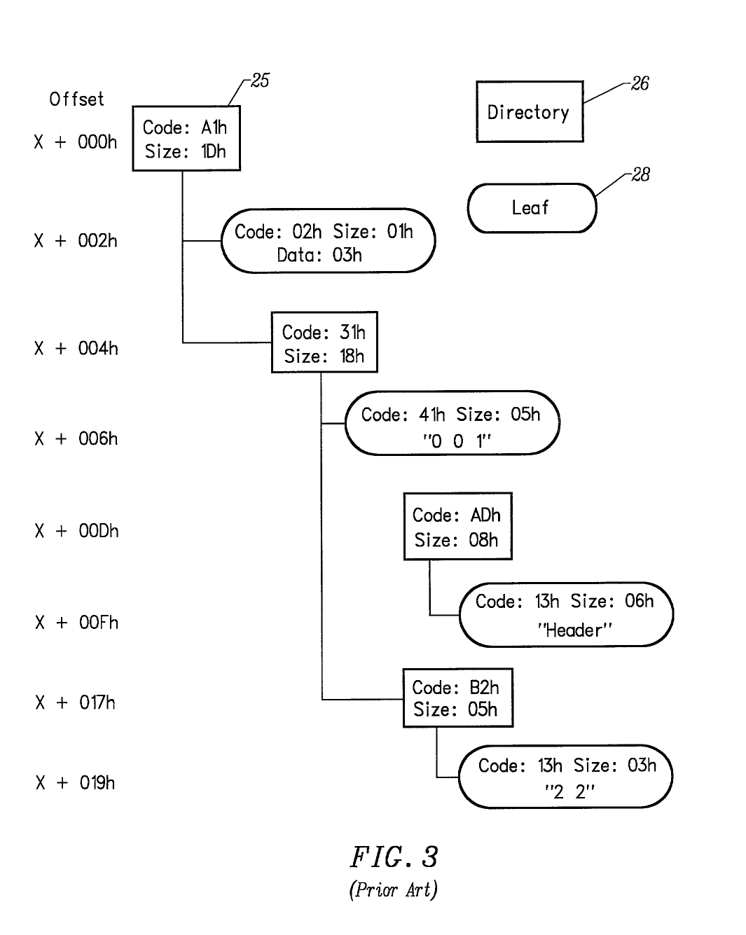

At the beginning of the RDO file (see FIG. 3) there is a 9-byte header which is not interpreted. After the header, the remainder of the file follows a common structure—that of a tree. A tree is a branched data structure that consists of intermediate directory nodes 26 and terminal leaf nodes 28. The structure is similar to that of a file system. A root folder contains several folders, i.e. directories, which, in turn, may contain more directories and/or individual files, i.e. leaves. At each directory, the tree forks into one or more branches, which ultimately terminate in leaves.

In the case of RDO, the distinction of directories vs. leaves is accomplished by prefixing each with an identifying code 25. A break-down of all codes is provided below in Table 1. This code is one byte long.

TABLE 1
Tree Codes

| | |
|---|---|
| Directory Codes | 04h, 8Ah, 3Xh, 6Xh, AXh, BXh, EXh |
| Leaf Codes | 02h, 06h, 12h, 13h, 4Xh, 8Yh, 9Xh |

After the code byte, the size of the remaining sub-tree is specified. If the first size byte is a number less than or equal to 127, this number equals the size, and the size specification is only one byte long. If, on the other hand, the first byte contains a value greater than or equal to 128 (highest bit set), the lower seven bits in this byte indicate the number of bytes to follow, which specify the actual size in big-endian order. For example, a size specification of 12h would mean a size of 18 bytes, whereas a size specification of 820110h would indicate a size of 110h=272 decimal bytes (where “h” stands for hexadecimal, a numbering system to the base of 16 that uses digits 0-9 and letters A-F).

Note that the size specification of a parent directory includes its entire contents, i.e. all child directories and leaves. FIG. 3 shows an example taken from a small section of an actual RDO file. Actual document data are contained only in leaves, while directories contain only branches.

Parsing Algorithm

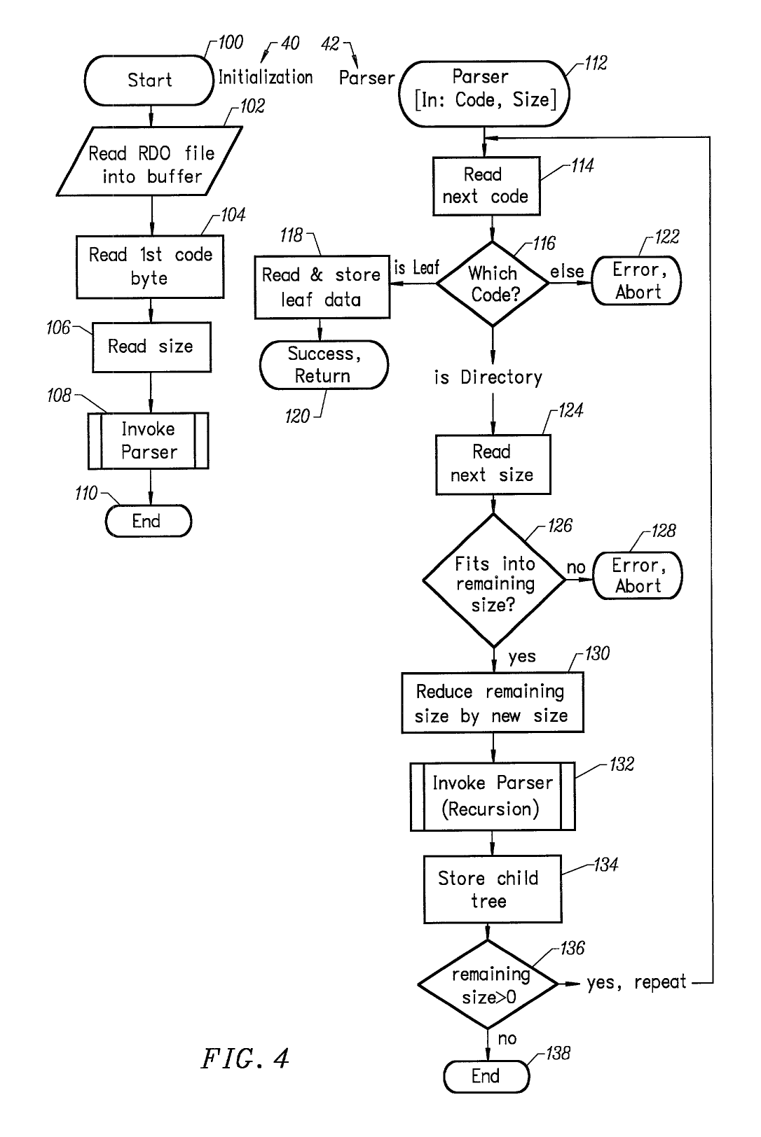

Now that the basic organization of the RDO file has been explained, an algorithm is described for parsing this tree structure into memory. The algorithm for doing so is depicted schematically in FIG. 4. With this algorithm, the RDO file is read into a tree data structure in computer memory. The actual data layout is chosen by the implementer, but is similar to that shown in FIG. 3.

The parser consists of an initialization function 40, which reads the RDO binary into memory, and a recursive parsing function 42, which reads data items from the binary into memory data structures.

At the start (100) of the initialization function 40, the RDO file is read into a buffer (102). A first code byte is read (104), the size byte(s) are read (106) and the parser is invoked (108). Upon return from the parser function 42, the initialization function 42 is complete (110).

During operation of the parser function, the next code is read (114) (the first code having been read during the initialization function). A code must be either a directory code or a tree code (116), according to Table 1. If the encountered code byte belongs to neither group, then an error is assumed and the process is aborted (122). Otherwise, a determination is made if the code is a leaf. If so, the leaf data are read and stored (118) and the process continues (120).

If the code is read as a directory, then the next size is read (124). If the size read does not fit into the remaining byte size (126), then an error is detected and the process is aborted (128). Otherwise, the remaining size is reduced by the size just read (130) and the parser is invoked again to process subordinate (‘child’) trees that may exist in the same fashion (132). The child tree is then stored (134). If the remaining size is greater than zero (136), the process is repeated to parse consecutive trees at the current level in the tree hierarchy. Otherwise, the process terminates (138).

Data Extraction

Once the RDO tree structure has been read into memory, it is necessary to extract the relevant document and page description data that is needed to generate the PDF output. The manner in which the various data items are laid out and contained within the RDO tree structure is described below.

The extraction of data from the tree structure can occur in a variety of ways.

One option is to create a template similar to the expected subtree and then attempt to match this template against all trees in the RDO file in a recursive fashion. The matching algorithm returns pointers to the sought leaves of the matching RDO tree. Once the template has been matched, the desired values can be read back from the pointers. Occasionally data may be encoded in the code of the directory, e.g. for the format of the page numbers (Arabic vs. Roman). In that case, the template must read back a pointer to the appropriate directory code as well.

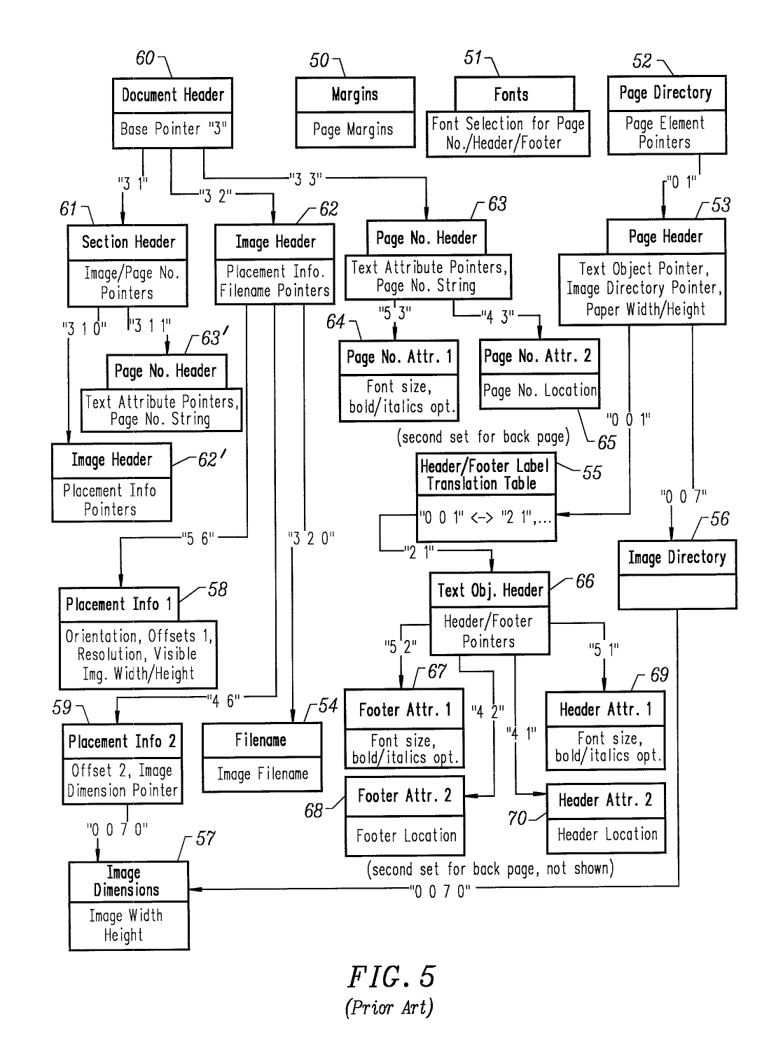

Another approach is to loop through all trees and call a specific handler routine based on the code of the topmost directory of each tree. The handler routine then (possibly recursively) attempts to follow a certain path of subdirectories through the subtree based on a predetermined sequence of codes to read the desired leaves with the data. The data are then stored in a fashion that associates the different pieces depicted in FIG. 5 with images or pages in the document. Details of how all relevant data is stored in the RDO trees are described below in the section “RDO Organization.”

Conversion to PDF

Once all data have been gathered from the RDO file, there is an internal representation of the following items:

For each page:

List of images on a page;

Optional header, footer, page number strings;

Location of these text items; and Fonts, font attributes, and sizes to be used

For each image:

The image dimensions;

Orientation and offset and alignment information; and

Information about the layering of multiple images on top of one another.

For the document:

A list of page images and page numbers;

A list of sections;

Font selection for header, footer and page number; and

Margins.

For each section:

A list of page images and page numbers.

Using standard off-the-shelf software, e.g. PDFlib (see PDFlib by Thomas Merz, PDFlib GmbH, (www.pdflib.com)), the PDF pages are generated by positioning each image on the page at the appropriate location using library functions, then adding the text strings, if any. Because PDF supports the inclusion of bitmaps by design, no further conversion of the page images is necessary. The result is a PDF file of the document. If some pages are included in RDO not as TIFF but as PostScript, these have to be converted explicitly to PDF and then be merged into the PDF output stream, e.g. using Acrobat Destiller by Adobe Systems, Inc.

### Tree Codes

The codes at the beginning of each tree element determine whether the element is a directory or a leaf, according to the Table 1 earlier.

In Table 1 above, X stands for all digits 0 . . . F and Y stands for all digits except A.

### RDO Organization

As explained above, the RDO file consists of a series of trees. Once the tree structure is parsed, the data in the individual leaves must be read. The following discussion presents all relevant parts of the parsed RDO file with annotations regarding their purpose.

The purpose of the data items is illustrated in FIG. 5. The various sections of document data are scattered throughout the file and are internally referenced through a set of strings used as labels and pointers. Typical examples for the labels are written along the arrows in FIG. 5. A pointer is a string that is used to refer to another section of the file, and a label is a string which identifies such a section that is being pointed to. The arrows indicate the direction of reference.

Conventions

There is no known published documentation of the RDO format. Thus, the names of the individual data groups were assigned by the inventor. These data items are all contained in various sections of the trees of the RDO file, as detailed in the parsed output below. The examples below are taken from different files to highlight certain special features. For clarity, not all trees are shown and sometimes sections within a tree may be omitted which is indicated with “[ . . . ]”.

All numbers in the parsed RDO excerpts are to be understood in hexadecimal format. In the discussion, terms such as “A1h tree” are used to refer to a top-level tree with directory code of A1h, the “h” standing for hexadecimal.

Margins

The margins 50 on the printable page are optional. If given, they are found at the beginning of the A0h tree. The margins are measured in the coordinate resolution. There is no label for the margins.

| | |
|---|---|
| DIRECTORY, code a0, size: 155 | |
| DIRECTORY, code e1, size: 18 | |
| LEAF, code 81 data: 04 b0 | <-- top margin |
| LEAF, code 82 data: 00 | <-- bottom margin |
| LEAF, code 83 data: 00 | <-- right margin |
| LEAF, code 84 data: 00 | <-- left margin |
| [...] | |

Filenames

The filenames 54 are also contained in the A0h tree and are listed consecutively in a deep subdirectory which also contains the label. The five leaves right at the beginning appear to be invariant.

```
DIRECTORY, code a0, size: 68d
  LEAF, code 80 data: 31 ‘1’  <--
  LEAF, code 85 data: 31 ‘1’  <--
  LEAF, code 84 data: 32 ‘2’  <-- invariants
  LEAF, code 86 data: 31 ‘1’  <--
  LEAF, code 87 data: 31 ‘1’  <--
  DIRECTORY, code ac, size: 5a2
    DIRECTORY, code 31, size: 40
    DIRECTORY, code a1, size: 08
      LEAF, code 13 data: 33 20 31 33 20 30 ‘3 13 0’  <-- label
    DIRECTORY, code a2, size: 34
      DIRECTORY, code a2, size: 32
      DIRECTORY, code 30, size: 30
        DIRECTORY, code a1, size: 22
        DIRECTORY, code 30, size: 20
          DIRECTORY, code a1, size: 1e
          DIRECTORY, code 04, size: 1c
            DIRECTORY, code 31, size: 1a
            LEAF, code 80 data: 2a 86 48 86 f7 0e 08 00 01 00
            ‘*H÷_{——}’
            LEAF, code 82 data: 30 30 30 30 30 30 30 45 2e 74
            69 66 ‘0000000E.tif’  <-- filename
            LEAF, code 06 data: 2a 86 48 86 f7 0e 08 03 07 03
            ‘*H÷_{——}’
    DIRECTORY, code 31, size: 3f
    DIRECTORY, code a1, size: 07
      LEAF, code 13 data: 33 20 35 20 30 ‘3 5 0’  <-- label
    DIRECTORY, code a2, size: 34
      DIRECTORY, code a2, size: 32
      DIRECTORY, code 30, size: 30
        DIRECTORY, code a1, size: 22
        DIRECTORY, code 30, size: 20
          DIRECTORY, code a1, size: 1e
          DIRECTORY, code 04, size: 1c
            DIRECTORY, code 31, size: 1a
            LEAF, code 80 data: 2a 86 48 86 f7 0e 08 00 01 00
            ‘*H÷_{——}’
            LEAF, code 82 data: 30 30 30 30 30 30 30 36 2e 74
            69 66 ‘00000006.tif’  <-- filename
            LEAF, code 06 data: 2a 86 48 86 f7 0e 08 03 07 03
            ‘*H÷_{——}’
[...]
```

Font Specification

The fonts 51 to be used for the page number; header and footer Text Objects are specified globally and are found at the end of the A0h tree. They carry no string labels, but note the value of the 02h leaf that indexes the Text Object font (see Table 2 below). The font selection is present regardless of whether or not page numbers, headers, or footers are actually used.

```
DIRECTORY, code a0, size: 12a
    [...]
    DIRECTORY, code a2, size: d5
    [...]
    DIRECTORY, code a9, size: 4a
      DIRECTORY, code a2, size: 48
        DIRECTORY, code 31, size: 16
```

| | |
|---|---|
| LEAF, code 02 data: 00 ‘_’ | <-- Text Object index |

```
          DIRECTORY, code 30, size: 11
            DIRECTORY, code a2, size: 0f
              DIRECTORY, code a8, size: 0d
                LEAF, code 81 data: 54 69 6d 65 73 2d 52 6f 6d 61 6e
```

| | |
|---|---|
| ‘Times-Roman’ | <-- page number font |

DIRECTORY, code 31, size: 16

| | |
|---|---|
| LEAF, code 02 data: 01 ‘_’ | <-- Text Object index |

```
            DIRECTORY, code 30, size: 11
              DIRECTORY, code a2, size: 0f
                DIRECTORY, code a8, size: 0d
                  LEAF, code 81 data: 54 69 6d 65 73 2d 52 6f
                  6d 61 6e
```

| | |
|---|---|
| ‘Times-Roman’ | <-- header font |

DIRECTORY, code 31, size: 16

| | |
|---|---|
| LEAF, code 02 data: 02 ‘_’ | <-- Text Object index |

```
            DIRECTORY, code 30, size: 11
              DIRECTORY, code a2, size: 0f
                DIRECTORY, code a8, size: 0d
                  LEAF, code 81 data: 54 69 6d 65 73 2d 52 6f
                  6d 61 6e
```

| | |
|---|---|
| ‘Times-Roman’ | <-- footer font |

TABLE 2
Meaning of Text Object index

| Text Object | | | |
|---|---|---|---|
| index value | 00 | 01 | 02 |
| Association | page number | header | footer |

Page Directory

The Page Directory 52 contains an entry with a pointer for each printable page, three in this example. In the A1h trees, as well as in the A6h trees, the first leaf holds a single-byte number that loosely corresponds to a level of indirection of this entity in the internal hierarchy. The Page Directory has a value of 0 (highest) because of its root status; it is not referred to by any other entity. This interpretation of these values, however, is not adhered to too literally in the RDO format.

```
DIRECTORY, code a1, size: 21
  LEAF, code 02 data: 00 ‘_’  <-- hierarchy level, 0 = highest
  DIRECTORY, code 31, size: 1c
    LEAF, code 41 data: 30 ‘0’
    DIRECTORY, code a0, size: 17
      DIRECTORY, code a1, size: 15
        DIRECTORY, code a0, size: 05
          LEAF, code 41 data: 30 20 31 ‘0 1’ <-- pointer to Page
```

Header

```
        DIRECTORY, code a0, size: 05
          LEAF, code 41 data: 30 20 32 ‘0 2’
        DIRECTORY, code a0, size: 05
          LEAF, code 41 data: 30 20 33 ‘0 3’
```

Header/Footer Label Translation Table

The RDO file uses two different types of pointers/labels to refer to the Text Object Header 66 for header and footer Text Objects. It is the purpose of the Label Translation Table 55 to equate both types with one another. This is done with four A1h trees for header and footer, for front and back pages, respectively. Additionally, there is a clear-text description of the object type, e.g. Header. For Page Number Text Objects, only one type of label, the “0 0 3” kind is used, and so the corresponding two trees link only those labels with a clear-text description, again for front and back page. In the example below, only the trees for the front page are shown. Notice also that the order of the labels “0 0 1,” etc. does not match the order of the Text Object indices of Table 2.

DIRECTORY, code a1, size: 1d
LEAF, code 02 data: 03 ‘_’ <-- hierarchy level, always 3 for

Translation Table

```
  DIRECTORY, code 31, size: 18
    LEAF, code 41 data: 30 20 30 20 31 ‘0 0 1’  <-- label type 1
    DIRECTORY, code ad, size: 08
      LEAF, code 13 data: 48 65 61 64 65 72 ‘Header’
    DIRECTORY, code b2, size: 05
      LEAF, code 13 data: 32 20 34 ‘2 1’  <-- label type 2
DIRECTORY, code a1, size: 1d
  LEAF, code 02 data: 03 ‘_’
  DIRECTORY, code 31, size: 18
    LEAF, code 41 data: 30 20 30 20 32 ‘0 0 2’
    DIRECTORY, code ad, size: 08
      LEAF, code 13 data: 46 6f 6f 74 65 72 ‘Footer’
    DIRECTORY, code b2, size: 05
      LEAF, code 13 data: 32 20 35 ‘2 2’
DIRECTORY, code a1, size: 1b
  LEAF, code 02 data: 03 ‘_’
  DIRECTORY, code 31, size: 16
    LEAF, code 41 data: 30 20 30 20 33 ‘0 0 3’
    DIRECTORY, code ad, size: 0d
      LEAF, code 13 data: 50 61 67 65 20 4e 75 6d 62 65 72 ‘Page
      Number’
```

Page Header

The Page Header 53 specifies the paper size in coordinate resolution and holds pointers to other elements on the page, namely the Image Directory 56, and text attributes for Text Objects 66-70. Note also the hierarchy level “2” here which is below the Page Directory 52 but still above the Image Directory 56. The paper size appears to be specified twice. The reason for that is unknown.

DIRECTORY, code a1, size: 53

| | |
|---|---|
| LEAF, code 02 data: 02 ‘_’ | <-- hierarchy level |

DIRECTORY, code 31, size: 4e

| | |
|---|---|
| LEAF, code 41 data: 30 20 31 ‘0 1’ | <-- label |

```
    DIRECTORY, code a0, size: 26
      DIRECTORY, code a1, size: 24
        DIRECTORY, code a0, size: 07
```

| | |
|---|---|
| LEAF, code 41 data: 30 20 30 20 37 ‘0 0 7’ | <-- pointer |

```
          to Image Directory
        DIRECTORY, code a1, size: 07
```

| | |
|---|---|
| LEAF, code 41 data: 30 20 30 20 31 ‘0 0 1’ | <-- pointer |

```
          to Header Text Attributes
        DIRECTORY, code a1, size: 07
```

| | |
|---|---|
| LEAF, code 41 data: 30 20 30 20 32 ‘0 0 2’ | <-- pointer |

```
          to Footer Text Attributes
        DIRECTORY, code a1, size: 07
```

| | |
|---|---|
| LEAF, code 41 data: 30 20 30 20 33 ‘0 0 3’ | <-- pointer |

```
          to Page Number Text Attributes
  DIRECTORY, code a4, size: 08
```

| | |
|---|---|
| LEAF, code 80 data: 27 d8 ‘ ‘Ø’ | <-- paper width |
| LEAF, code 80 data: 33 90 ‘3’ | <-- paper height |

```
  DIRECTORY, code af, size: 06
    LEAF, code 80 data: 00 ‘_’
    LEAF, code 80 data: 00 ‘_’
  DIRECTORY, code b0, size: 0d
    DIRECTORY, code 30, size: 08
      LEAF, code 80 data: 27 d8 ‘ ‘Ø’  <- redundant (?) paper width
      LEAF, code 80 data: 33 90 ‘3’  <- redundant (?) paper height
    LEAF, code 02 data: 01 ‘_’
```

Image Directory

The Image Directory 56 lists pointers to Image Dimension tables 57 for all images that are included on a given page. In most cases, the page consists only of a single page image, but occasionally there may be more. The example below lists two. Note that the level of indirection is now three.

If a page contains multiple images, there are multiple Image Dimension objects 57 listed in the Image Directory 56. If the images overlap, the order of the labels given in the Image Directory 56 indicates the order of the layering with the first-mentioned label corresponding to the bottom-most image.

```
DIRECTORY, code a1, size: 29
  LEAF, code 02 data: 03 ‘_’  <-- hierarchy indirection
  DIRECTORY, code 31, size: 24
    LEAF, code 41 data: 30 20 30 20 32 37 ‘0 0 27’  <-- label
    DIRECTORY, code a0, size: 1a
      DIRECTORY, code a1, size: 18
        DIRECTORY, code a0, size: 0a
          LEAF, code 41 data: 30 20 30 20 32 37 20 30 ‘0 0 27 0’
          <-- pointer to Image Dimension object
        DIRECTORY, code a0, size: 0a
          LEAF, code 41 data: 30 20 30 20 32 37 20 31 ‘0 0 27 1’
```

Image Dimensions

The Image Dimension object 57 contains, as the name implies, the dimensions of the bitmap in coordinate resolution. Note that particularly for scanned pages, the image is frequently supplied in landscape mode and is rotated by the coordinate transformation specifications to portrait. The image width and height given here should match the actual image width and height of the TIFF bitmaps.

The last leaf, 85h, is the opacity of the image background color, with a value of “0” meaning transparent, and “1” meaning opaque. This setting is relevant only for pages with multiple, layered images.

```
DIRECTORY, code a1, size: 24
  LEAF, code 02 data: 03 ‘_’
  DIRECTORY, code 31, size: 1f
    LEAF, code 41 data: 30 20 30 20 32 37 20 30 ‘0 0 27 0’  <--
    label, order of layering
    DIRECTORY, code a4, size: 08
      LEAF, code 80 data: 33 90 ‘3’  <-- image width
      LEAF, code 80 data: 27 d0 ‘ ‘_’  <-- image height
    DIRECTORY, code ad, size: 06
      LEAF, code 13 data: 42 6f 64 79 ‘Body’
      LEAF, code 85 data: 01 ‘_’  <-- opacity, 1 = opaque
```

Text Object Headers

As used herein, the term “Text Objects” refers to the header, footer, and page number entities that consist of a textual message, font specification, and placement information on the page. The Text Object Headers 66 of the A5h tree described below aggregate most of this data or pointers to it in a single place for each Text Object. There are up to four Text Object Headers which contain the text message of the header or footer and pointers to Text Attribute objects 67-70. The reason there are four is because they may be assigned differently for front and back pages in duplex printing. The label used here is identified with the labels used in the Page Header 53 via the Label Translation Table 55 discussed earlier. The font selection is not referred to by label, but by Text Object index number.

```
DIRECTORY, code a5, size: 1f
  LEAF, code 02 data: 02 ‘_’
  DIRECTORY, code 31, size: 1a
    LEAF, code 41 data: 32 20 31 ‘2 1’  <-- label
  DIRECTORY, code aa, size: 09
    LEAF, code 80 data: 48 65 61 64 69 6e 67 ‘Heading’  <-- text
    message
  LEAF, code 91 data: 35 20 31 ‘5 1’  <-- pointer to Text
```

Attribute 1

LEAF, code 93 data: 34 20 31 ‘4 1’ <-- pointer to Text

Attribute 2

Text Attributes

The Text Objects are associated with two kinds of Text Attributes 67-70, one that controls the font size and options such as italics or bold (“Text Attribute 1”), and one that controls the placement of the text string on the page (“Text Attribute 2”). The Text Attributes are found in A7h and A8h trees with labels that are used by the Text Object Header 66. Below is one example of each attribute. There are a total of six attributes, for page number, header and footer, for front and back pages, identified again by a Text Object index number.

Attribute 1: 67, 69

This attribute specifies the font size and font style. The latter is controlled by the two leaves below marked “italics” and “bold.” Italics is selected when the corresponding leaf assumes a value of 03h, bold is selected when the respective leaf is set to 01h. Other values appear to have no significance. Font styles can be mixed.

```
DIRECTORY, code a7, size: 26
  LEAF, code 45 data: 35 20 30 ‘5 0’  <-- label
  DIRECTORY, code a3, size: 1f
    LEAF, code 06 data: 58 02 06 02 ‘X_{——}’
    DIRECTORY, code a0, size: 17
      DIRECTORY, code ac, size: 08
        DIRECTORY, code a0, size: 06
          LEAF, code 80 data: 0a ‘_’  <-- font size in points
          LEAF, code 81 data: 00 ‘_’  <-- Text Object index
      DIRECTORY, code aa, size: 0b
        DIRECTORY, code 31, size: 09
          LEAF, code 02 data: 0a ‘_’
          LEAF, code 02 data: 17 ‘_’  <-- italics attribute
          LEAF, code 02 data: 16 ‘_’  <-- bold attribute
```

Attribute 2: 68, 70

The second attribute determines whether or not the associated Text Object is displayed or not by setting the 8Ch leaf to “Hidden” or to the respective name of the Text Object, e.g. “Page Number.” The placement of the text on the page is determined by the offsets and entries for horizontal and vertical justification. Up to four different offsets may occur, their meaning is determined by the leaf code. Which offsets are applied depends on the justification code (see Table 3 below). Note that for centered horizontal justification, the horizontal offsets are ignored. The offsets are measured in coordinate resolution.

```
DIRECTORY, code a8, size: if
  LEAF, code 45 data: 34 20 30 ‘4 0’
  DIRECTORY, code a4, size: 18
    DIRECTORY, code a4, size: 08
```

| | |
|---|---|
| LEAF, code 81 data: 04 b0 ‘_°’ | <-- Offset |
| LEAF, code 83 data: 04 b0 ‘_°’ | <-- Offset |
| LEAF, code 85 data: 01 ‘_’ | <-- vertical justification |

```
    LEAF, code 8c data: 48 69 64 64 65 6e ‘Hidden’  <-- determines
    whether Text Object is displayed
```

| | |
|---|---|
| LEAF, code 8e data: 01 ‘_’ | <-- horizontal justification |

TABLE 3
Text Object justification and offset
entries (an “X” refers to the
value applied)

| | | | leaf 81h | | leaf 83h |
|---|---|---|---|---|---|
| | | leaf 80h | (from | leaf 82h | (from |
| Justification | Leaf value | (from left) | right) | (from top) | bottom) |
| horizontal | 00 (left) | X | | | |
| (leaf 8Eh) | 01 (right) | | X | | |
| | 02 (center) | | | | |
| vertical | 00 (top) | | | X | |
| (leaf 85h) | 01 (bottom) | | | | X |

Rotation, Offsets, Resolution—lmage Placement Information

Information regarding the placement of the page image bitmap is contained in an A7h and an A8h tree for each image.

Placement Info 1 (58):

The A7h tree contains information on:

The orientation of the image on the page. The rotation byte can assume values which stand for rotation by 0, 90, 180, 270 degrees about the default origin (top left corner of image) after application of the pre-rotation offsets. The default RDO coordinate system is left-handed, i.e. the X-axis points right and the Y-axis points down, so that the rotation is understood in clockwise fashion.

The pre-rotation offsets in image resolution, x₀ and y₀, which are to be applied prior to the rotation.

The window width and height, w₀ and h₀.

Two resolutions: the coordinate resolution and the image resolution. Both resolutions are given in dots per inch. Dividing any size or measurement given in the RDO file by the appropriate resolution yields the value in inches. The image resolution refers to the resolution of the TIFF bitmap and is the unit of the pre-rotation offsets and window width/height. All other measurements, e.g. post-rotation offsets, image width/height, etc., are based on the coordinate resolution. In typical RDO documents, the image resolution is often 600 dpi and the coordinate resolution 1200 dpi.

```
DIRECTORY, code a7, size: 32
  LEAF, code 45 data: 35 20 36 ‘5 6’
  DIRECTORY, code a3, size: 2b
    LEAF, code 06 data: 58 02 07 02 ‘X_{——}’
    DIRECTORY, code a1, size: 23
      LEAF, code 80 data: 03 ‘_’  <-- rotation byte
      DIRECTORY, code a4, size: 12
        DIRECTORY, code a0, size: 06
          LEAF, code 02 data: 00 ‘_’  <-- pre-rotation offset x₀
          LEAF, code 02 data: 01 ‘_’  <-- pre-rotation offset y₀
        DIRECTORY, code a1, size: 08
          LEAF, code 02 data: 19 c6 ‘_ [symbol] ’ <-- window width w₀
          LEAF, code 02 data: 13 eb ‘_ë  <-- window height h₀
      DIRECTORY, code a5, size: 0a
        DIRECTORY, code a0, size: 08
          LEAF, code 02 data: 04 b0 ‘_°’  <-- coordinate resolution
          LEAF, code 02 data: 02 58 ‘_X’  <-- image resolution
```

Placement Info 2 (59):

The A8h tree contains two post-rotation offsets, x₁ and y₁, by which the image is shifted after the rotation has been applied. Furthermore, there are two pointers to Image Dimension and Image Directory objects.

```
DIRECTORY, code a8, size: 25
  LEAF, code 45 data: 34 20 36 ‘4 6’ <-- label
  DIRECTORY, code a4, size: 1e
    DIRECTORY, code a4, size: 06
      LEAF, code 80 data: 01 ‘_’  <-- post-rotation offset x₁
      LEAF, code 82 data: 01 ‘_’  <-- post-rotation offset y₁
    LEAF, code 8b data: 30 20 30 20 37 20 30 ‘0 0 7 0’  <--
    pointer to Image Dimension object
    LEAF, code 87 data: 30 20 30 20 37 ‘0 0 7’  <-- pointer to
    Image Directory
    LEAF, code 8c data: 42 6f 64 79 ‘Body’
```

Variant:

If more than one bitmap is placed on a page, then the A8 tree looks as above only for the bottom-most page image. Images layered on top make reference to the Image Header 62 of the bottom-most image and to the Image Directory 56, as shown below:

```
DIRECTORY, code a8, size: 31
  LEAF, code 45 data: 34 20 31 30 ‘4 10’ <-- label
  DIRECTORY, code a4, size: 29
    DIRECTORY, code a4, size: 07
```

| | |
|---|---|
| LEAF, code 80 data: 00 ‘_’ | <-- post-rotation offset x₁ |
| LEAF, code 82 data: 19 c8 ‘_È’ | <-- post-rotation offest Y₁ |

```
    LEAF, code 8b data: 30 20 30 20 38 20 32 ‘0 0 8 2’ <--
    pointer to Image Dimension object
    DIRECTORY, code 8a, size: 0f
      LEAF, code 80 data: 33 20 31 39 20 37 ‘3 19 7’  <-- pointer
      to Image Header for bottom image
      LEAF, code 81 data: 30 20 30 20 38 ‘0 0 8’  <-- pointer to
      Image Directory
    LEAF, code 8c data: 42 6f 64 79 ‘Body’
```

The window width and height are internal variables used by the document preparation software. The width and height of the visible image, wᵥ and hᵥ, in the final result are given by the formulae:

wᵥ=w₀−x₀ and hᵥ=h₀−y₀

Document Header, Section Header, Image Header, Page Number Header

In the RDO format, a document can comprise:

Zero or more sections which carry an internal name that does not appear on the output. Each section may contain one or more page images.

Zero or more individual page images not belonging to any specific section, referred to herein as section-less page images.

For each section or page image, there is a Section Header 61 or Image Header 62, respectively. The Document Header 60 lists pointers to all sections and section-less page images in the document. If sections are present, the Section Header 61 represents an additional level of indirection, grouping the pointers to the Image Headers 62 for the section. As is apparent from the nomenclature chosen, the fundamental entity is an image, not a page. The reason for this is that there may be multiple images making up a page. In typical documents, however, there is usually only one image per page.

In addition to Image Headers, there may be a Page Number Header 63 for each page. It is present only if page numbering is enabled in Text Attribute 2, 68, 70.

The document header specifies a base pointer, e.g. “3” from which pointers to the sections or section-less images are derived by appending the substrings specified. Section headers append another substring for the image pointers of that section. Page Number Header 63 pointers are listed along with pages and conform to the same pointer scheme.

Additionally, the 02h leaf contains a number identifying the level in the header hierarchy, similar to the levels of indirection in the Page Directory 52. The Document Header resides at the highest level (0), the Section Headers at level 1, the Image Header and Page Number Header at level 2 (lowest). Document Header:

DIRECTORY, code a6, size: 1e
LEAF, code 02 data: 00 ‘_’ <-- hierarchy level, 0 = highest,

Document Header

```
  DIRECTORY, code 31, size: 19
    LEAF, code 41 data: 33 ‘3’  <-- base pointer
    DIRECTORY, code a0, size: 14
      LEAF, code 12 data: 31 35 ‘15’  <-- substrings to form
```

section/image pointers

```
      LEAF, code 12 data: 31 36 ‘16’
      LEAF, code 12 data: 31 39 ‘19’
      LEAF, code 12 data: 31 32 ‘12’
      LEAF, code 12 data: 32 30 ‘20’
```

Image Header 62:

The Image Header 62 contains a substring (“0” here) that when concatenated with the label for the Image Header 62 (“3 15” here) yields a pointer to the filename 54 for the TIFF image file to which this header refers. Then, there are pointers to the two Image Placement Information 58-59 objects and lastly, the Alignment code. The Alignment plays a role only if non-zero margins are specified in which case the second character of the Alignment string specifies the boundary of the bitmap to be aligned with the respective margin, according to Table 4 below. For example, an Alignment code of ‘c’ specifies that the top and right edges of the bitmap are to be aligned with the top right page boundary, subject to coordinate offsets, if any.

TABLE 4
Alignment codes, the second
character of Alignment string

| Vertical | Horizontal | Alignment code |
|---|---|---|
| top | left | ‘a’ |
| top | center | ‘b’ |
| top | right | ‘c’ |
| center | left | ‘d’ |
| center | center | ‘e’ |
| center | right | ‘f’ |
| bottom | left | ‘g’ |
| bottom | center | ‘h’ |
| bottom | right | ‘i’ |

```
DIRECTORY, code a6, size: 1e
  LEAF, code 02 data: 02 ‘_’  <-- hierarchy level, 2 = lowest
  DIRECTORY, code 31, size: 19
  LEAF, code 41 data: 33 20 31 35 ‘3 15’  <-- label, constructed
  from “3” and “15” in document header
  DIRECTORY, code a1, size: 03
```

| | |
|---|---|
| LEAF, code 12 data: 30 ‘0’ | <-- substring for filename |
| LEAF, code 91 data: 35 20 36 ‘5 6’ | <-- Image Placement Info 1 |
| LEAF, code 93 data: 34 20 36 ‘4 6’ | <-- Image Placement Info 2 |
| LEAF, code 99 data: 6f 61 ‘oa’ | <-- Alignment, 2nd character |

Page Number Header 63:

The Page Number Header 63 appears only if page numbering is enabled. It specifies:

an optional prefix string to be printed before the actual page number digits;

an optional suffix string to be printed after the page number digits;

the style of the page number digits;

the starting page number, if pages are not consecutively numbered; and

pointers to the Page Number Attributes 64, 65.

If a group of pages is numbered consecutively, only the first page in the group specifies the starting page number of the consecutive batch; the Page Number Headers 63 of subsequent pages do not contain this 80h leaf. The prefix and suffix leaves may be missing, too. The numbering style is given by the directory code following the prefix leaf, according to Table 5 below.

TABLE 5
Page number digit style

| Code: A3h | Code: A7h | Code: A6h |
|---|---|---|
| Arabic (1, 2, 3, 4, 5, ...) | lower case Roman (i, ii, | upper case Roman |
| | iii, iv, v, ...) | (I, II, III, IV, V, ...) |

DIRECTORY, code a6, size: 4f

| | |
|---|---|
| LEAF, code 02 data: 02 ‘_’ | <-- hierarchy level |

DIRECTORY, code 31, size: 4a

| | |
|---|---|
| LEAF, code 41 data: 33 20 31 36 ‘3 16’ | <-- label |

```
    DIRECTORY, code a9, size: 14
      DIRECTORY, code 31, size: 12
        LEAF, code 80 data: 50 61 67 65 20 4e 75 6d 62 65 72 ‘Page
        Number’
        DIRECTORY, code a2, size: 03
          LEAF, code 80 data: 01 ‘_’ <-- beginning page number (may
          be missing)
    DIRECTORY, code aa, size: 22
      LEAF, code 80 data: 50 61 67 65 20 2d 2d 20 ‘Page -- ’ <--
```

Page number prefix

DIRECTORY, code a6, size: 11 <-- Directory code determines

numbering style

```
        DIRECTORY, code a4, size: 0f
          LEAF, code 80 data: ‘ ’
          LEAF, code 13 data: 50 61 67 65 20 4e 75 6d 62 65 72 ‘Page
          Number’
      LEAF, code 80 data: 20 2d 2d ‘-- ’  <-- Page number suffix
    LEAF, code 91 data: 35 20 30 ‘5 0’  <-- Page Number Attribute 1
    LEAF, code 93 data: 34 20 30 ‘4 0’  <-- Page Number Attribute 2
```

Section Header 61:

The Section Header 61 provides an additional level of indirection. It groups pages together and has a name which, however, is not printed and used only in the document preparation software. As in the Document Header 60, pointers for Image Headers 62 and Page Number Headers 63 are constructed by appending the substrings listed to the section label.

```
DIRECTORY, code a6, size: 57
  LEAF, code 02 data: 01 ‘_’ <-- hierarchy level, 1 = Section
  Header
  DIRECTORY, code 31, size: 52
    LEAF, code 41 data: 33 20 31 39 ‘3 19’ <-- Label
    DIRECTORY, code a0, size: 06
      LEAF, code 12 data: 30 ‘0’ <-- Substrings for Image
      Pointers/Page Number Pointers
      LEAF, code 12 data: 31 ‘1’
    LEAF, code 8e data: [...] <-- Section name, not printed
    LEAF, code 99 data: 6f ‘o’
```

### Job Ticket

One objective of this invention is to provide a process that extracts all possible information stored in a job ticket file. RDO files may be accompanied by a binary “.xjt” job ticket file which contains information related to additional printing features supported by a particular set of printers.

The information contained in the job ticket file is typically not included with the PDF document file converted from RDO as it corresponds to a very specific class of printers. This information can, however, be saved in a readable form in a separate file so that it can be used, when required.

### Structure of the XJT Job Ticket

The XJT job ticket specifies printing options that are not directly part of the document and that depend on the capabilities of the output device, for example, a job ticket may specify what kind of covering is required, if the printer is capable of binding the document. There are several options like this, and are sequentially described below. These options will be called “features” from now onwards. We have divided various features in to six groups which we call “feature types”. The six feature types are: Basic features, Additional features, Job notes, Exception pages, Page inserts and Cover features. We now describe these feature types in detail.

Basic Features

Copies: Number of copies of the document, to be printed.

Page Selection: Range of pages, which are to be printed.

Sides Imaged: Sides of a page, which are to be printed (Simplex/Duplex).

Paper Stock: 10 paper stocks are specified in the XJT job ticket. The main paper stock is used for printing the document. The others can be used by page inserts or exception pages (explained later in this document). A paper stock has the following properties:

1. Size

2. Type (Standard, Transparency, Precut Tab, Fullcut Tab, Custom, Printer Default)

3. Drilled or not

4. Color

5. Weight per unit area

Finishing: Specifies the stapling options.

Collation: Collated or Non-Collated

More Features (Additional Features)

The XJT job ticket specifies certain additional features like distance by which image is to be shifted while printing (listed below). All these specifications are in mm. Apart from this, a job can also be saved in a file rather than printed. In such a case, the job ticket specifies the filename.

Side 1 x Image Shift.

Side 1 y Image Shift.

Side 2 x Image Shift (if duplex printing is specified).

Side 2 y Image Shift (if duplex printing is specified).

Destination: Specifies whether the job is to be printed or to be saved in a file.

Destination directory: Directory in which the job is to be saved.

Job Notes

Job notes is the information that might be useful for identifying a job. It includes the following items:

Job Name.

From.

Account.

Deliver To.

Banner Message.

Special Instructions.

Exception Pages

The XJT job ticket file may contain special instructions for including several sets of exception pages. These exception page specifications describe pages which are to be printed on a different paper stock than the one defined for the document as a whole. An exception page specification has the following components:

Range of pages.

Paper stock to be used.

Sides Imaged.

Image shift specifications.

Page Inserts

The XJT job ticket may contain special instructions for inserting pages in the job from alternative sources. A typical page insert has following components:

Page number, after which the pages are to be inserted.

Number of pages to be inserted.

Paper stock to be used.

Covers

The XJT job ticket also specifies the type of covers that may be selected for a particular job. The following items are specified in the job ticket:

Sides Covered (front or back or both).

Front cover paper stock (if required).

Back cover paper stock (if required).

Sides to be printed for front cover (if required).

Sides to be printed for back cover (if required).

### Data Extraction

Once the job ticket file is read in memory, we can extract the relevant information. We now describe the relative memory locations where the features described above are stored. We will assume that each memory word is one byte long. Each word can represent numerical data or an ASCII character. Textual data is represented as a null-terminated string of ASCII characters. Whenever some numerical data is stored in several words, the first one is least significant and the last one is most significant.

Overall structure of XJT job ticket

Table 6.1 describes the overall structure of the XJT job ticket. The first column lists the feature and second column specifies the type to which this feature belongs. The offset is the relative memory location of the particular feature from the beginning of job ticket. Feature types “Exception pages” and “Page inserts” are not included in this table as they appear at the end of the job ticket and don't have fixed memory locations. This is explained in detail in subsequent sections (Tables 6.2 and 6.3). Table 6.4 describes the structure of the paper stock. All ten paper stocks follow the same structure as described in this table.

Tables 6.5-6.15 explain how to interpret the values of various features described in Table 6.1. Note that the feature entries below are not always contiguous. In these cases, the gaps are padded with zero values.

TABLE 6.1
Overall structure of a job ticket

| | | Offset | |
|---|---|---|---|
| Feature | Feature Type | (length) | Interpretation |
| Number of Copies | Basic | 24 | |
| Page Selection (From) | Basic | 32 | |
| Page Selection (To) | Basic | 36 | |
| Finishing | Basic | 40 (1) | Table 6.10 |
| Side 1 x Image shift | Additional | 60 | |
| Side 1 y Image shift | Additional | 64 | |
| Side 2 x Image shift | Additional | 68 | |
| Side 2 y Image shift | Additional | 72 | |
| No. of | Exception | 76 | |
| Exception Pages | page | | |
| No. of Page Inserts | Page Insert | 80 | |
| Sides to be covered | Cover | 96 | Table 6.14 |
| Front cover sides to be | Cover | 100 | Table 6.15 |
| printed | | | |
| Back cover sides to be | Cover | 104 | Table 6.15 |
| printed | | | |
| Front Paper Stock | Cover | 108 | Table 6.13 |
| Back Paper Stock | Cover | 112 | Table 6.13 |
| Main Paper Stock | Basic | 124 | Table 6.13 |
| Paper Stock 2 | Basic | 218 | Table 6.13 |
| Paper Stock 3 | Basic | 312 | Table 6.13 |
| Paper Stock 4 | Basic | 406 | Table 6.13 |
| Paper Stock 5 | Basic | 500 | Table 6.13 |
| Paper Stock 6 | Basic | 594 | Table 6.13 |
| Paper Stock 7 | Basic | 688 | Table 6.13 |
| Paper Stock 8 | Basic | 782 | Table 6.13 |
| Paper Stock 9 | Basic | 876 | Table 6.13 |
| Paper Stock 10 | Basic | 970 | Table 6.13 |
| Destination | Additional | 1065 | Table 6.12 |
| Collation | Basic | 1069 | Table 6.11 |
| Sides Imaged | Basic | 1070 (1) | Table 6.9 |
| Account | Job Notes | 1113 | |
| From | Job Note | 1126 | |
| Deliver to | Job Note | 1167 | |
| Special Instructions | Job Note | 1228 | |
| Banner Message | Job Notes | 1329 | |
| Custom finish name | Basic | 1531 | |
| Save Directory | Additional | 1562 (253) | Table 6.12 |

Exception Pages

Each exception page is specified in 40 bytes, at the end of the job ticket file. The number of exception pages is specified at location 76 of the job ticket file. The length of a job ticket file without exception pages and page inserts is 2620. So if there is only one exception page, it starts at location 2620 and ends at location 2659. If there is more than one exception pages, they follow after the first one, each taking 40 bytes of memory.

TABLE 6.2
Features of an exception page.

| Exception Page Feature | Relative memory location* | Length |
|---|---|---|
| Pages (From) | 0 | 3 |
| Pages (To) | 4 | 3 |
| Sides Imaged** | 30 | 1 |
| Side 1 x Image Shift | 8 | 1 |
| Side 1 y Image Shift | 12 | 1 |
| Side 2 x Image Shift | 16 | 1 |
| Side 2 y Image Shift | 20 | 1 |
| Paper Stock** | 28 | 2 |

*These memory locations are relative to the beginning of the exception page data and not to the beginning of job ticket file.
**These features can be interpreted with the help of tables 6.9 and 6.13 respectively.

Page Inserts

The number of page inserts is stored at the location 80 (1 byte) of the job ticket file. Data for every page insert is kept in 12 byte blocks located at the end of job ticket file (after the exception page data). So if there is one page insert, information related to it is stored at the memory location 2620+40* (Number of exception pages). If there are more than one page inserts, they follow the first one and each takes 12 bytes of memory.

TABLE 6.3
Page insert features.

| Page Insert Feature | Relative Memory Location* | Length |
|---|---|---|
| After page | 0 | 3 |
| Quantity | 4 | 3 |
| Paper Stock** | 8 | 2 |

*These memory locations are relative to the beginning of the page insert data and not to the beginning of job ticket file.
**The paper stock features can be interpreted using table 6.13

Paper Stocks (Basic Feature): Data for each paper stock is stored in a sequence of 94 bytes that have a fixed format. We now describe the offsets of various data relative to the start location of paper stock.

TABLE 6.4
Paper stock features

| Feature of Paper Stock | Location of the feature | Length |
|---|---|---|
| Color** | 0 | 2 |
| Paper Type** | 4 | 1 |
| Size** | 8 | 2 |
| Custom Width^{§} | 12 | 2 |
| Custom Height^{§} | 14 | 2 |
| Weight/unit area | 16 | 1 |
| Ordered type flag^{§} | 19 | 1 |
| Order count^{§} | 20 | 1 |
| Tab positions^{§§} | 21 | 1 |
| Drilled or not** | 23 | 1 |
| Name of color^{§} | 28 | 31 |
| Name of custom type^{§} | 59 | 31 |

**These features can be interpreted using the tables 6.5-6.8.
^{§}Applies only if custom options are used for corresponding feature, see tables 6.5-6.6.
^{§§}Applies only if tab stock, see table 6.6.

Size (Paper Stock Feature)

TABLE 6.5
Sizes of paper stock

| Value | Meaning |
|---|---|
| 1 | 8.5 × 11.0 in. (U.S. |
| | Letter) |
| 2 | 8.5 × 14.0 in. |
| 4 | 17.0 × 11.0 in. (Legal) |
| 8 | 9.0 × 11.0 in. |
| 16 | 210 × 297 mm. (A4) |
| 32 | 8.5 × 13.0 in. |
| 64 | 223 × 297 mm |
| 128 | 420 × 297 mm (A3) |
| 256 | Custom Paper Size |
| 512 | Default |
| 1024 | 250 × 353 mm (ISO B4) |
| 2048 | 257 × 364 mm (JIS B4) |

Type (Paper Stock Feature)

TABLE 6.6
Paper Types of paper stock

| Value | Stands for |
|---|---|
| 1 | Standard |
| 2 | Transparency |
| 4 | Precut Tab |
| 8 | Fullcut Tab |
| 16 | Custom paper type |

Drilled or not (Paper Stock Feature)

TABLE 6.7

| Value | Stands for |
|---|---|
| 1 | Not Drilled |
| 2 | Drilled |

Color (Paper Stock Feature)

TABLE 6.8
Various colors for a paper stock

| Value | Stands for | Comments |
|---|---|---|
| 1 | White | |
| 2 | Pink | |
| 4 | Yellow | |
| 8 | Blue | |
| 16 | Green | |
| 32 | Clear | |
| 64 | Custom Color | Name of color at 28-57 |
| 128 | Printer Default | |
| 256 | Buff | |
| 512 | Golden Rod | |

Sides Imaged (Basic Feature)

TABLE 6.9
Sides to be printed

| Value | Stands For |
|---|---|
| 1 | Simplex Printing |
| 2 | Duplex Printing |
| 4 | Duplex Printing (tumbled) |

Finishing (Basic Feature)

TABLE 6.10
Finishing option for a job

| Value | Stands for | Comments |
|---|---|---|
| 1 | No finishing | |
| 2 | Single Portrait | |
| 4 | Single Landscape | |
| 8 | Dual Landscape | |
| 16 | Bound | |
| 32 | Slip Sheets | |
| 64 | Booklet Maker | |
| 128 | Printer Default | |
| 256 | Custom | Custom finishing name at |
| | | offset 1531-1560 |
| 1024 | Right Portrait Staple | |
| 2048 | Right Landscape Staple | |
| 4096 | Right Dual Landscape Staple | |
| 8192 | Right Bound | |

Collation (Basic Feature)

TABLE 6.11
Collation

| Value | Stands for |
|---|---|
| 1 | Collated |
| 2 | Non-collated |
| 4 | Printer Default |

Destination (Additional Feature)

TABLE 6.12
Destination

| Value | Stands for | Comments |
|---|---|---|
| 1 | Print | |
| 2 | Save | destination directory at offset 1562-1814 |

Paper Stock (Exception Page/Page Insert/Cover Feature)

TABLE 6.13
Paper Stock

| Value | Stands for |
|---|---|
| 0 | Main paper stock |
| 1 | Paper stock 2 |
| 2 | Paper stock 3 |
| 4 | Paper stock 4 |
| 8 | Paper stock 5 |
| 16 | Paper stock 6 |
| 32 | Paper stock 7 |
| 64 | Paper stock 8 |
| 128 | Paper stock 9 |
| 256 | Paper stock 10 |

Sides to be Covered

TABLE 6.14
Sides to be covered

| Value | Stands for |
|---|---|
| 1 | None |
| 2 | Front only |
| 4 | Back only |
| 8 | Front and back same |
| 16 | Front and back different |

Front/Back Cover Sides to be Printed

TABLE 6.15
Cover sides to be printed

| Value | Stands for |
|---|---|
| 1 | None |
| 2 | Print on side 1 |
| 4 | Print on side 2 |
| 8 | Print on both sides |

Although the invention is described herein with reference to the preferred embodiment, one skilled in the art will readily appreciate that other applications may be substituted for those set forth herein without departing from the spirit and scope of the present invention. For example, while the presently preferred embodiment of the invention concerns the conversion of a document in the RDO format to the PDF format, it will be appreciated by those skilled in the art that, based upon the disclosure herein, documents in the RDO format may readily be converted to other formats as desired, using only those techniques known to those skilled in the art.

Accordingly, the invention should only be limited by the Claims included below.

1. A method for analyzing a binary RDO file structure, extracting all relevant data needed to reproduce content thereof, and generating an output in a selected format, comprising the steps of:
reading and analyzing said binary RDO file;
extracting data contained within said RDO file describing an arrangement of pages in a final document; and
generating an output by placing one or more bitmap files for each page onto an output page and adding optional text messages for header, footer, and page number.

2. The method of claim 1, said reading and analyzing step further comprising:
decoding said binary RDO file internal structure;
parsing said binary RDO file; and
transferring said parsed binary RDO file into a data structure representation in a memory.

3. The method of claim 1, said extracting step further comprising:
collecting data for each page in said RDO binary file, where said data are scattered throughout said RDO binary file, and where some data are page-invariant and that apply to an entire document embodied in said RDO binary file.

4. The method of claim 3, wherein said page-invariant data comprise any of header and footer messages, their location, or font selection or margin specifications.

5. The method of claim 1, wherein said bitmap file is a TIFF format file.

6. The method of claim 1, further comprising the step of:
storing said output in a memory when all pages have been processed.

7. The method of claim 1, wherein said selected format is a PDF format.

8. The method of claim 1, wherein said bitmap file is a PostScript file and wherein an external, commercially available Postscript-to-PDF converter is invoked to merge these pages into an output PDF.

9. An apparatus for analyzing a binary RDO file structure, extracting all relevant data needed to reproduce content thereof, and generating an output in a selected format, comprising:
a read module for reading and analyzing said binary RDO file;
an understand module for extracting data contained within said RDO file describing an arrangement of pages in a final document; and
a reproduce module for generating an output by placing a bitmap file for each page onto an output page and adding optional text messages for header, footer, and page number.

10. The apparatus of claim 9, said read module further comprising:
a decoder for decoding said binary RDO file internal structure;
a parser for parsing said binary RDO file; and
a memory for receiving a data structure representation of said parsed binary RDO file.

11. The apparatus of claim 9, said understand module further comprising:
a mechanism for collecting data for each page in said RDO binary file, where said data are scattered throughout said RDO binary file, and where some data are page-invariant and that apply to an entire document embodied in said RDO binary file.

12. The apparatus of claim 11, wherein said page-invariant data comprise any of header and footer messages, their location, or font selection.

13. The apparatus of claim 9, wherein said bitmap file is a TIFF format file.

14. The apparatus of claim 9, further comprising:
a memory for storing said output when all pages have been processed.

15. The apparatus of claim 9, wherein said selected format is a PDF format.

16. The apparatus of claim 9, wherein said bitmap file is a PostScript file.

17. The apparatus of claim 16, further comprising:
an external, commercially available Postscript-to-PDF converter for merging said bitmap file for each of said pages into an output PDF.

18. The apparatus of claim 9, wherein said output comprises an internal representation of any of the following items once all data have been gathered from said RDO file:
for each page a list of images on a page; optional header, footer, and page number strings; location of text items; and fonts, font attributes, and sizes to be used;
for each image image dimensions; orientation and offset and alignment information; and information about layering of multiple images on top of one another;
for said RDO document a list of page images and page numbers; a list of sections; font selection for header, footer and page number; and margins;
for each section a list of page images and page numbers.

19. A method for analyzing a binary RDO file structure, extracting all relevant data needed to reproduce content thereof, and generating an output in a selected format, comprising the steps of:
reading and analyzing said binary RDO file;
extracting data contained within said RDO file describing an arrangement of pages in a final document; and
generating an output by placing one or more bitmap files for each page onto an output page and adding optional text messages for header, footer, and page number decoding said binary RDO file internal structure;
parsing said binary RDO file into a tree data structure; and
transferring said parsed binary RDO file as said tree data structure representation to a memory.

20. The method of claim 19, wherein said step of parsing said tree structure comprises an initialization function which reads said RDO binary into memory and a recursive parsing function.

21. The method of claim 20, wherein said initialization function comprises the step of:
reading said RDO file into a buffer, wherein a first code byte is read, a size byte is read, and said parsing function is invoked.

22. The method of claim 21, wherein said parsing function comprises the steps of:
reading the next code;
making a determination if said code is a leaf and, if so, said leaf data are read and stored and said process continues, wherein if said code is read as a directory, then a next size is read and, if said size read does not fit into a remaining byte size, then an error is detected and said process is aborted, otherwise remaining size is reduced by a new size and said parsing function is invoked to effect recursion, wherein upon return, a child tree is then stored, and if a remaining size is greater than zero said process is repeated, otherwise said process terminates.

23. The method of claim 19, wherein said extracting step comprises any of:
creating a template similar to an expected subtree and then attempting to match said template against all trees in said RDO file in a recursive fashion, wherein a matching algorithm returns pointers to sought leaves of a matching RDO tree, and wherein once said template has been matched, desired values can be read back from said pointers; and
looping through all trees and calling a specific handler routine based on the code of a topmost directory of each tree, wherein a handler routine then (optionally recursively) attempts to follow a certain path of subdirectories through a subtree based on a predetermined sequence of codes to read desired leaves with said data, and wherein said data are then stored in a fashion that associates different pieces with images or pages in said document.

24. The method of claim 19, further comprising:
providing a separate job ticket file which specifies printing options that are not directly part of said document and that depend on capabilities of an output device; and
extracting information stored in said job ticket file, which information relates to features supported by a particular device or set of devices.

25. The method of claim 24, wherein said job ticket files specifies any of:
number of copies of said docuemnt to be printed;
a range of pages of said document which are to be printed;
sides of a page of said document which are to be printed;
paper stock to be used for printing said document, wherein a paper stock may have any of the following properties: size, type, drilled or not, color, weight per unit area, stapling options, and collation;
distance by which image is to be shifted while printing;
whether a job is to be printed or to be stored in a particular file;
information that is useful for identifying a job, which information may include of: name of a document to be printed, name of a user who is sending a request to print, account, deliver to, banner message, and special instructions;
special instructions for including several sets of exception pages which describe pages which are to be printed with printer settings that are different from those defined for said document as a whole, wherein an exception page specification may have any of the following components: range of pages, paper stock to be used, sides imaged, and image shift specifications;
special instructions for inserting pages in said job from alternative sources, which instruction may comprise any of the following components: page number after which pages are to be inserted, number of pages to be inserted, and paper stock to be used; and
type of covers that must be printed for a particular job, which may specify any of the following: where a cover is required, front cover paper stock if required, back cover paper stock if required, sides to be printed for front cover if required, and sides to be printed for back cover if required.
